(19) United States
(12) Patent Application Publication
(10) Pub. No.: US 2014/0137250 A1
(43) Pub. Date: May 15, 2014

(54) SYSTEM AND METHOD FOR DETECTING FINAL DISTRIBUTION SITE AND LANDING SITE OF MALICIOUS CODE

(71) Applicant: KOREA INTERNET & SECURITY AGENCY, Seoul (KR)

(72) Inventors: Tai Jin LEE, Seoul (KR); Byung Ik KIM, Seoul (KR); Hong Koo KANG, Seoul (KR); Chang Yong LEE, Seoul (KR); Ji Sang KIM, Seoul (KR); Hyun Cheol JEONG, Seoul (KR)

(73) Assignee: KOREA INTERNET & SECURITY AGENCY, Seoul (KR)

(21) Appl. No.: 14/062,044

(22) Filed: Oct. 24, 2013

(30) Foreign Application Priority Data
Nov. 9, 2012 (KR) 10-2012-0126426

(51) Int. Cl. H04L 29/06

(52) U.S. Cl. CPC H04L 63/145
USPC 726/23

(57) ABSTRACT

A system and method for detecting final distribution and landing sites of a malicious code. The method extracts and collecting new article URLs and advertisement banner URLs by inspecting a main page of a press company; filters malicious-suspected URLs suspicious of hiding the malicious code from the new article URLs and the advertisement banner URLs; collects files created when the malicious-suspected URLs are visited, through visit inspection; self-inspects the created files collected through the created file collection using a commercial vaccine; and traces, if the malicious code is detected in the created file, the final distribution and landing sites distributing the detected malicious code.

### BACKGROUND OF THE INVENTION

1. Field of the Invention

The present invention relates to a system and method for detecting final distribution and landing sites of a malicious code, which detects the final distribution and landing sites distributing a malicious code by inspecting a web page of a press company.

2. Background of the Related Art

Although a lot of people may use the Internet regardless of time and space owing to advancement in information communication technologies and distribution of portable terminals, serious social problems, such as leakage of personal information, Distributed Denial of Service (DDoS) attacks, cyber terrors, disclosure of privacy and the like, are generated through the Internet.

Therefore, since the prior art inspects only URLs in a main page of a press company or collected newspaper articles, it is unable to separately inspect newly created newspaper articles and previously posted newspaper articles, other than the main page.

In addition, in the prior art, although articles of press companies distribute malicious codes through advertisement banner URLs, it is difficult to collect the malicious codes distributed through the advertisement banner URLs since the advertisement banner URLs are not independently collected.

### SUMMARY OF THE INVENTION

Therefore, the present invention has been made in view of the above problems, and it is an object of the present invention to provide a system and method for detecting final distribution and landing sites of a malicious code, which detects the final distribution and landing sites of the malicious code by parsing a main page of each category of a main page (home page) of a press company and collecting and inspecting URLs of new articles.

In addition, another object of the present invention is to provide a system and method for detecting final distribution and landing sites of a malicious code, which extracts an advertisement banner URL by analyzing a web page source of a press company, detects the malicious code distributed through the advertisement banner, and detects the final distribution and landing sites of the corresponding malicious code.

To accomplish the above objects, according to one aspect of the present invention, there is provided a method of detecting final distribution and landing sites of a malicious code, the method including the steps of: extracting and collecting new article URLs and advertisement banner URLs by inspecting a main page of a press company; filtering malicious-suspected URLs suspicious of hiding the malicious code from the new article URLs and the advertisement banner URLs; collecting files created when the malicious-suspected URLs are visited, through visit inspection; self-inspecting the created files collected through the created file collection using a commercial vaccine; and tracing, if the malicious code is detected in the created file, the final distribution and landing sites distributing the detected malicious code.

In addition, the step of collecting the new article URLs and the advertisement banner URLs includes the steps of: extracting the main page of each category by crawling the main page of a press company; and extracting the new article URLs and the advertisement banner URLs from the main page of each category.

In addition, the step of extracting new article URLs and advertisement banner URLs includes the steps of: extracting the new article URLs mainly from a ‘title’ or a ‘summary’ comment by analyzing a web page source of an inspection target URL of each category; and extracting the advertisement banner URLs mainly from a banner tag by analyzing a web page source of an inspection target URL of each category.

In addition, according to another aspect of the present invention, there is provided a system for detecting final distribution and landing sites of a malicious code, the system comprising: a URL filtering server for extracting and collecting new article URLs and advertisement banner URLs by inspecting a main page of a press company and filtering malicious-suspected URLs suspicious of hiding the malicious code from the new article URLs and the advertisement banner URLs; a URL visit inspection server for collecting files created when the malicious-suspected URLs are visited, through visit inspection; a collected file self-inspection server for self-inspecting the created files collected through the created file collection using a commercial vaccine; a landing/distribution site periodic inspection server for tracing and periodically inspecting, if the malicious code is detected in the created file, the final distribution and landing sites distributing the detected malicious code; and a management server for collecting and managing information output from the main page of a press company and each of the servers.

In addition, the URL filtering server extracts the main page of each category by crawling the main page of a press company and extracts the new article URLs and the advertisement banner URLs by crawling the main page of each category.

In addition, the URL filtering server extracts the advertisement banner URLs by analyzing web page sources of the new article URLs.

### BRIEF DESCRIPTION OF THE DRAWINGS

FIG. 1 is a block diagram showing a system for detecting final distribution and landing sites of a malicious code according to the present invention.

FIG. 2 is a view showing an example of inspecting a web page of a press company related to the present invention.

FIG. 3 is a view showing an example of extracting banner URLs from a web page of a press company related to the present invention.

FIG. 4 is a flowchart illustrating a method of detecting final distribution and landing sites of a malicious code according to the present invention.

### DESCRIPTION OF REFERENCE CHARACTERS

10: Management server
20: URL filtering server
30: URL visit inspection server
40: Collected file self-inspection server
50: Landing/distribution site periodic inspection server

### DETAILED DESCRIPTION OF THE PREFERRED EMBODIMENT

An embodiment according to the present invention will be hereafter described in detail with reference to the accompanying drawings.

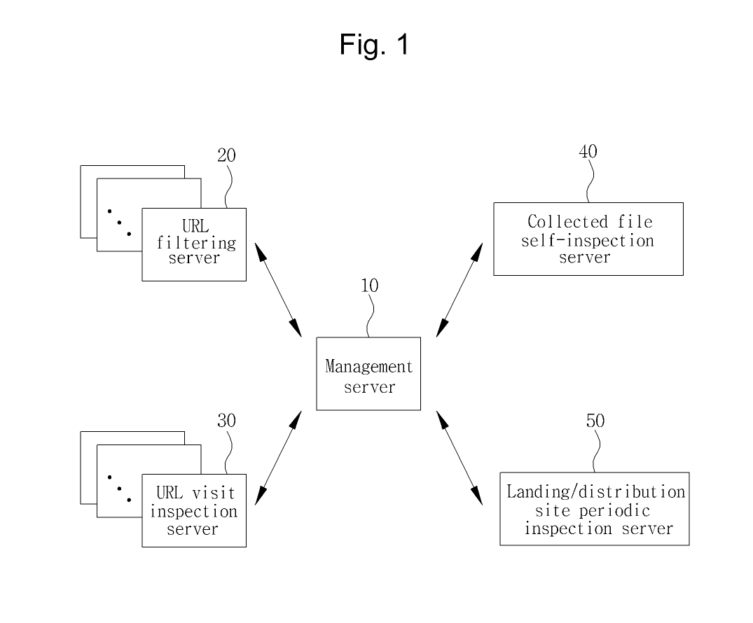

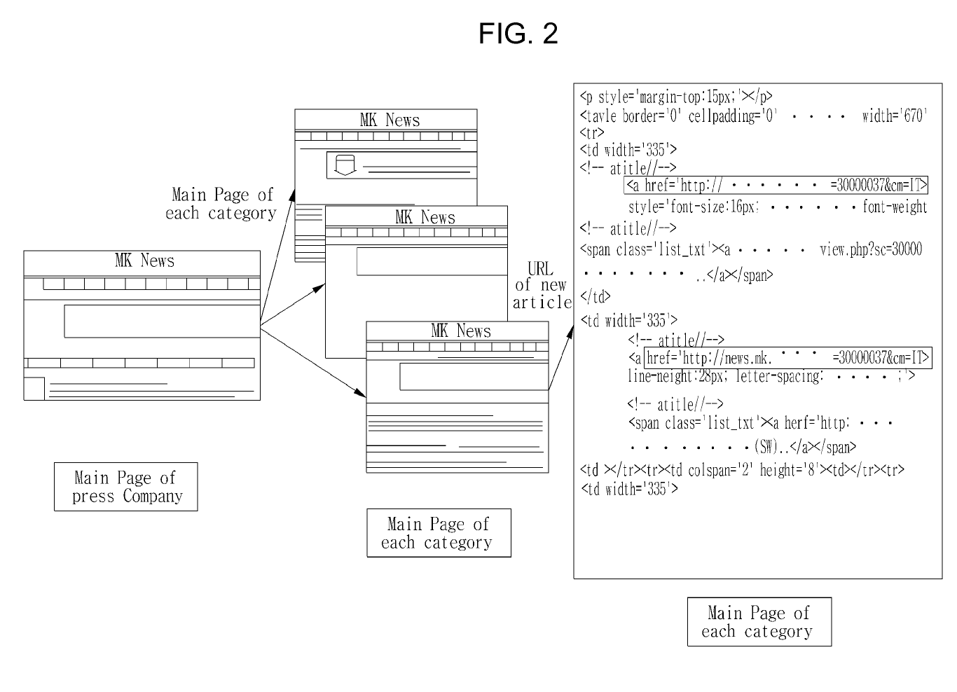

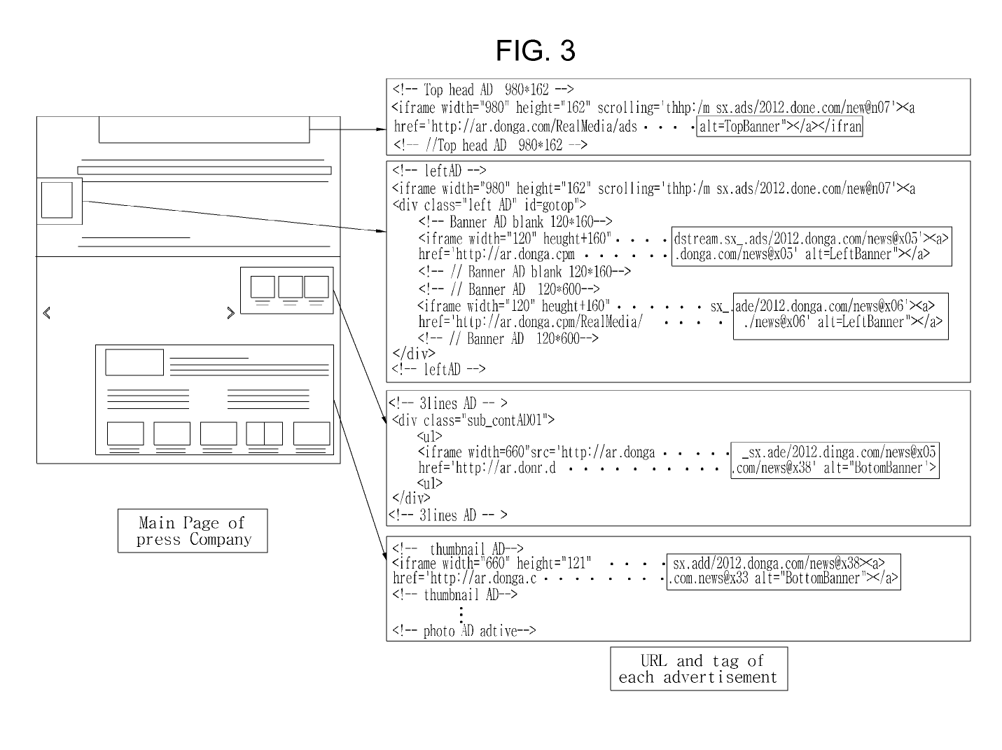

FIG. 1 is a block diagram showing a system for detecting final distribution and landing sites of a malicious code according to the present invention, FIG. 2 is a view showing an example of inspecting a web page of a press company related to the present invention, and FIG. 3 is a view showing an example of extracting banner URLs from a web page of a press company related to the present invention.

Referring to FIG. 1, the system for detecting final distribution and landing sites of a malicious code according to the present invention includes a management server 10, a uniform resource locator (URL) filtering server 20, a URL visit inspection server 30, a collected file self-inspection server 40, and a landing/distribution site periodic inspection server 50.

The management server 10 collects and manages inspection target URLs and manages a virtual machine, crawling and a database (hereinafter, referred to as DB). Here, the inspection target URLs include URLs collected through a blacklist providing site, a spam trap, a web, a social networking service (SNS) and an SNS trap, URLs of press companies/web advertisement banner companies, periodic inspection URLs of each group, URLs input by a manager and the like.

The management server 10 manages malicious-suspected URLs, collected files and analysis results of the malicious-suspected URLs in the form of a DB and manages information on policies. Here, the information on policies includes a URL collection policy, a URL inspection policy, a periodic inspection policy, a keyword collection policy and the like.

If an inspection target URL is received from the management server 10, the URL filtering server 20 extracts and collects sub-URLs of each depth connected to the inspection target URL by performing web crawling on the inspection target URL. At this point, the URL filtering server 20 analyzes the web page source of the inspection target URL and extracts a part of the web page source where a link exists. Here, the link part includes a src part of a script, a URL of an ‘a href’, a URL included in a URL tag, a ‘src’ part of an img and the like.

The URL filtering server 20 adjusts collection depth of a sub-URL according to depth information of a sub-URL collection policy transmitted from the management server 10. The depth information may be changed by a manager.

The URL filtering server 20 extracts an inspection target URL (a main page) of each category by crawling the main page of a press company and collects URLs of new articles by parsing the extracted inspection target URL of each category. At this point, the URL filtering server 20 extracts and collects URLs of new articles, i.e., HTTP links such as ‘a href’ and ‘src’, mainly from a ‘title’ or a ‘summary’ comment by analyzing the web page source of the inspection target URL of each category as shown in FIG. 2.

In addition, the URL filtering server 20 parses web banners when a main page of a press company is inspected. For example, as shown in FIG. 3, the URL filtering server 20 extracts advertisement banner URLs using a banner tag such as ‘XXXBanner’ from a link such as ‘iframe’, ‘a href’ or the like in the web page of the extracted inspection target URL of each category.

In addition, the URL filtering server 20 may extract advertisement banner URLs by analyzing the web page source of the URL of a new article.

In addition, the URL filtering server 20 extracts malicious-suspected URLs suspicious of hiding a malicious code by inspecting web page sources of inspection URLs including inspection target URLs and sub-URLs thereof, inspection target URLs of each category, new article URLs and advertisement banner URLs. The URL filtering server 20 inspects whether or not a hidden area exists in a web page source, inspects whether or not an obfuscated script exists in the web page source, downloads a file which is created when an inspection URL is connected, and confirms whether the downloaded file is an executable file or a Portable Executable (PE) file starting with Mark Zbikowsky (MZ).

If at least one of inspection results including results of the hidden area inspection, the obfuscated inspection and a file structure inspection is suspected to be malicious, the URL filtering server 20 selects a corresponding URL as a malicious-suspected URL suspicious of hiding a malicious code. Then, the URL filtering server 20 transmits a malicious-suspected URL list including URLs selected as a malicious-suspected URL to the management server 10.

If the malicious-suspected URL list is received from the management server 10, the URL visit inspection server 30 detects a file creation URL by connecting to the malicious-suspected URLs received through multiple browsers and confirming whether or not a file is created. At this point, the URL visit inspection server 30 receives the malicious-suspected URL list in accordance with the maximum number of URLs that can be visited at the same time.

The URL visit inspection server 30 performs a single browser inspection on the file creation URL extracted through the multiple browser inspection, collects a file which is created when the corresponding URL is connected, and transmits the created file to the management server 10.

If the created file is received from the management server 10, the collected file self-inspection server 40 immediately detects whether or not a malicious code is hiding in the created file using a commercial vaccine. At this point, the collected file self-inspection server 40 activates an automatic update function and a real-time monitoring function of the vaccine according to a vaccine driving policy received from the management server 10.

The collected file self-inspection server 40 creates a white list of normal files in which a malicious code is not detected among the created files and periodically re-inspects the created files existing in the white list. In addition, the collected file self-inspection server 40 transmits the created files in which a malicious code is detected among the collected files to the management server 10.

The landing/distribution site periodic inspection server 50 traces a final distribution site distributing the malicious code detected by the collected file self-inspection server 40 by tracing a network route. The landing/distribution site periodic inspection server 50 confirms information on a landing site connected to the final distribution site and registers the landing site as a periodic inspection target before registering the detected final distribution site as a periodic inspection target.

The landing/distribution site periodic inspection server 50 confirms whether the final distribution and landing sites confirmed as distributing the malicious code are active (alive or dead) at predetermined inspection intervals. That is, the landing/distribution site periodic inspection server 50 periodically inspects whether or not the final distribution and landing sites registered as periodic inspection targets are connectible.

The landing/distribution site periodic inspection server 50 may request an action to be taken against distribution of the corresponding malicious code by transmitting malicious code information of the periodic inspection target URLs, information on the final distribution site of the malicious code, and information on the collected malicious codes to another system such as a sink roll system and an MC-Finder, a malicious code analysis system, or a zero-day detection system.

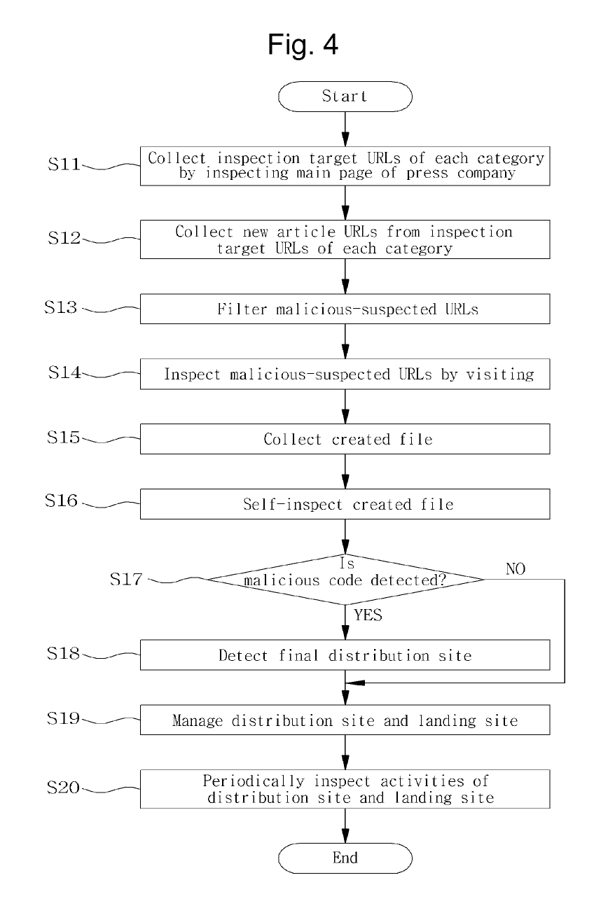

FIG. 4 is a flowchart illustrating a method of detecting final distribution and landing sites of a malicious code according to the present invention.

Referring to FIG. 4, the URL filtering server 20 collects inspection target URLs of each category from the management server 10 by crawling the main page of a press company S11.

In addition, the URL filtering server 20 collects new article URLs and advertisement URLs by crawling the inspection target URLs collected by inspecting the main page of a press company S12. At this point, the URL filtering server 20 extracts HTTP links, such as ‘a href’, ‘src’ and the like, as the new article URLs by inspecting mainly a part where a ‘title’ or a ‘summary’ comment is used on the web pages of the extracted inspection target URLs of each category. In addition, the URL filtering server 20 extracts the advertisement URLs mainly from a ‘XXXBanner’ tag in a link such as ‘iframe’, ‘a href’ or the like on the web pages of the extracted inspection target URLs of each category. Here, the URL filtering server 20 may additionally extracts and collects sub-URLs connected to the new article URLs and the advertisement URLs by analyzing web page sources of the new article URLs.

The URL filtering server 20 filters malicious-suspected URLs suspicious of hiding a malicious code among the collected new article URLs by inspecting possibility of hiding a malicious code through the analysis of web page sources of the collected new article URLs S13. The URL filtering server 20 transmits a list of the filtered malicious-suspected URLs to the management server 10.

The URL visit inspection server 30 receives the malicious-suspected URL list from the management server 10 and inspects whether or not a file is created after connecting to the received malicious-suspected URLs S14.

Then, the URL visit inspection server 30 collects files which are created when the received malicious-suspected URLs are connected S15. The URL visit inspection server 30 registers the collected files in the DB of the management server 10.

The collected file self-inspection server 40 receives the collected files from the DB of the management server 10 and performs self-inspection on the received files S16. The collected file self-inspection server 40 confirms whether or not a malicious code exists in the created files in real-time using a commercial vaccine of a latest version.

If a malicious code is detected in the created files, the collected file self-inspection server 40 transmits a file creation URL creating the corresponding file to the landing/distribution site periodic inspection server 50 through the management server 10.

The landing/distribution site periodic inspection server 50 receiving the file creation URL traces a final distribution site distributing the malicious code detected from the created files S18. The landing/distribution site periodic inspection server 50 detects the final distribution site of the malicious code by tracing a network route.

If trace of the final distribution site is completed, the landing/distribution site periodic inspection server 50 confirms a landing site connected to the final distribution site and registers and manages the landing site together with the final distribution site in the DB of the management server 10.

The landing/distribution site periodic inspection server 50 confirms whether or not the final distribution and landing sites registered in the DB of the management server 10 are active at predetermined inspection intervals S20. That is, the landing/distribution site periodic inspection server 50 confirms whether or not the currently managed final distribution site and landing site are connectible. The landing/distribution site periodic inspection server 50 updates the DB of the management server 10 according to a result of the periodic inspection.

The present invention may extracts and collect new article URLS by inspecting web pages of a press company and detect final distribution and landing sites of a malicious code distributed through the new article URLs.

In addition, the present invention may extract advertisement banner URLs by analyzing web page sources of a press company and detect final distribution and landing sites of a malicious code distributed through the advertisement banner URLs.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of detecting final distribution and landing sites of a malicious code, the method comprising the steps of:
extracting and collecting new article URLs and advertisement banner URLs by inspecting a main page of a press company;
filtering malicious-suspected URLs suspicious of hiding the malicious code from the new article URLs and the advertisement banner URLs;
collecting files created when the malicious-suspected URLs are visited, through visit inspection;
self-inspecting the created files collected through the created file collection using a commercial vaccine; and
tracing, if the malicious code is detected in the created file, the final distribution and landing sites distributing the detected malicious code.

2. The method according to claim 1, wherein the step of collecting the new article URLs and the advertisement banner URLs includes the steps of:
extracting the main page of each category by crawling the main page of a press company; and
extracting the new article URLs and the advertisement banner URLs from the main page of each category.

3. The method according to claim 2, wherein the step of extracting new article URLs and advertisement banner URLs includes the steps of:
extracting the new article URLs mainly from a ‘title’ or a ‘summary’ comment by analyzing a web page source of an inspection target URL of each category; and
extracting the advertisement banner URLs mainly from a banner tag by analyzing a web page source of an inspection target URL of each category.

4. A system for detecting final distribution and landing sites of a malicious code, the system comprising:
a URL filtering server for
extracting and collecting new article URLs and advertisement banner URLs by inspecting a main page of a press company and
filtering malicious-suspected URLs suspicious of hiding the malicious code from the new article URLs and the advertisement banner URLs;
a URL visit inspection server for collecting files created when the malicious-suspected URLs are visited, through visit inspection;
a collected file self-inspection server for self-inspecting the created files collected through the created file collection using a commercial vaccine;
a landing/distribution site periodic inspection server for tracing and periodically inspecting, if the malicious code is detected in the created file, the final distribution and landing sites distributing the detected malicious code; and
a management server for collecting and managing information output from the main page of a press company and each of the servers.

5. The system according to claim 4, wherein the URL filtering server extracts the main page of each category by crawling the main page of a press company and extracts the new article URLs and the advertisement banner URLs by crawling the main page of each category.

6. The system according to claim 5, wherein the URL filtering server extracts the advertisement banner URLs by analyzing web page sources of the new article URLs.
